(19) United States
(12) Patent Application Publication
(10) Pub. No.: US 2022/0235777 A1
(43) Pub. Date: Jul. 28, 2022

(54) VACUUM PUMP AND PROTECTION MEMBER PROVIDED IN VACUUM PUMP

(71) Applicant: Edwards Japan Limited, Yachiyo-shi (JP)

(72) Inventors: Yoshihiro Enomoto, Narashino (JP); Takashi Kabasawa, Chiba-shi (JP)

(21) Appl. No.: 17/611,816

(22) PCT Filed: May 22, 2020
(86) PCT No.: PCT/JP2020/020401

§ 371 Date: Nov. 16, 2021

(30) Foreign Application Priority Data
May 30, 2019 (JP) 2019-101785

(51) Int. Cl. F04D 19/04

(52) U.S. Cl. CPC F04D 19/042; F04D 29/058; F04D 19/048

(57) ABSTRACT

A vacuum pump in which a spark is not generated even when a rotor component and a stator component are brought into contact, and an explosive reaction in a vacuum container can be prevented, and a protection portion provided in the vacuum pump are provided. On head part sides of a thread ridge to a thread ridge of a threaded spacer with a narrow clearance of a gas channel therebetween, a protection portion 1a to a protection portion made of non-metal are formed in a peripheral state. A protection portion is similarly formed in the peripheral state also on an inner peripheral surface side of a stator blade spacer opposed to a distal end of a rotor blade with a narrow clearance of the gas channel. The protection portion is formed of non-metal with a sufficient thickness so that metal materials of base materials are not brought into contact with each other even when a rotor blade and a stationary portion are brought into contact with each other.

This application is a U.S. national phase application under 35 U.S.C. § 371 of international application number PCT/JP2020/020401 filed on May 22, 2020, which claims the benefit of priority to JP application number 2019-101785 filed on May 30, 2019. The entire contents of each of international application number PCT/JP2020/020401 and JP application number 2019-101785 are incorporated herein by reference.

### TECHNICAL FIELD

The present disclosure relates to a vacuum pump and a protection portion provided in the vacuum pump and particularly to such a vacuum pump that a spark is not generated even if a rotor component is brought into contact with a stator component, and an explosive reaction in a vacuum container can be prevented and a protection portion provided in the vacuum pump.

### BACKGROUND

With recent development of electronics, a demand for semiconductors such as memories and integrated circuits has rapidly increased.

These semiconductors are manufactured by imparting electric characteristics by doping impurities on a semiconductor substrate with extremely high purity, by forming a fine circuit on the semiconductor substrate by etching or the like.

And these works need to be performed in a vacuum container in a high vacuum state in order to avoid an influence by dusts and the like in the air. A vacuum pump is used in general for exhausting of this vacuum container, and a turbo-molecular pump, which is one of a vacuum pump, is used in many cases from a viewpoint particularly of a small amount of a remaining gas, easy maintenance and the like.

Moreover, in a manufacturing process of a semiconductor, there are many processes in which various process gasses are caused to act on a semiconductor substrate, and the turbo-molecular pump is used not only for evacuating an inside of the vacuum container but also for exhausting these process gasses from the inside of the vacuum container.

The process gas in a high temperature state is introduced into the vacuum container in order to improve reactivity in some cases.

When these process gasses are compressed to a certain pressure during exhausting, they become solid and precipitate a product in an exhaust system in some cases. And this type of the process gas can adhere to and deposit in the turbo-molecular pump in some cases.

There is a concern that this product can cause a serious trouble by a mechanism described below.

(1) A rotor blade and a stator blade could be brought into contact by some unpredictable factor during an operation of the pump. The contact particularly occurs in threaded spacer portions in a vicinity of an outlet port in many cases. At this time, a spark is generated by the contact between metals.

(2) A reactive product deposited in the pump explosively reacts with (1) as a trigger.

(3) As a result of (2), a pressure inside the pump and in a vacuum container connected to this pump rapidly increases.

(4) Components of the pump or the vacuum container are broken, and a gas inside is blown into the atmospheric air.

Since some of the gas used for manufacture of the semiconductor, a flat panel and the like and by-products generated during the manufacturing process are harmful substances to human bodies, occurrence of the above could lead to a serious accident.

Conventionally, there have been few troubles as above, but with a recent change in materials for the semiconductor, the flat panel and the like, there is a risk of occurrence of the trouble as above.

This risk has not been conventionally assumed and thus, there are no measures against it. Therefore, though objects are different from that of the present application, Japanese Patent Application Publication No. 2005-325792 and Japanese Patent Application Publication No. 2006-233978 paying attention to coating on the rotor blade and the stator blade similarly to the present application are cited as examples of the conventional art.

Japanese Patent Application Publication No. 2005-325792 is an example in which a fluorine-resin coating was provided on a rotor blade, a stator blade, and a spacer installed between the stator blades in order to improve emissivity.

Japanese Patent Application Publication No. 2006-233978 is an example in which the emissivity was improved by providing an epoxy resin layer on a surface of Ni plating applied to the rotor blade. And several tens μm is recommended as a thickness of the resin layer.

### SUMMARY

However, since heat conductivity of the resin layer is not so good, if the thickness of the resin layer is increased, heat is not emitted easily. Moreover, if the resin layer is made thicker, a cost is raised for that portion.

Furthermore, when the resin layer is to be bonded on a rotor blade side, the resin layer with an increased thickness needs to be bonded with high adhesion in order to avoid a concern of removal from a surface.

Therefore, in order to improve emissivity of heat, as recommended to be several tens μm in Japanese Patent Application Publication No. 2006-233978, thin coating on a surface of metal has been an idea of the conventional art.

However, with the thickness of the resin layer at approximately several tens μm, the resin layer could be broken easily at contact between the rotor blade and the stator blade, and base materials of the metal are brought into contact with each other. Thus, generation of sparks cannot be prevented, and prevention of an accident cannot be expected.

The present disclosure was made in view of the conventional problems as described above and has an object to provide a vacuum pump in which a spark does not occur any more even at contact between a rotor component and a stator component and an explosive reaction in a vacuum container can be prevented, and a protection portion provided in the vacuum pump.

Thus, the present disclosure describes examples of a vacuum pump having an outer cylinder, a rotor shaft supported rotatably in the outer cylinder, a rotary drive means for driving the rotor shaft to rotate, a rotor blade made of metal and having a blade row fixed to the rotor shaft, a stationary portion made of metal and constituted by at least any one of a stator blade installed between the blade row of the rotor blades, a stator blade spacer for holding the stator blade with a predetermined interval, and a stator installed in a periphery of the rotor blade, an exhaust channel formed between the rotor blade and the stationary portion, and a protection portion made of non-metal and having such a thickness that can prevent contact between the metals when the rotor blade and the stationary portion are brought into contact provided at least on a part of the rotor blade and the stationary portion.

The protection portion made of non-metal and having such a thickness that can prevent contact between the metals is provided at least on a part of the rotor blade and the stationary portion. Thus, even if the rotor blade and the stationary portion are brought into contact, the metals are not exposed or contacted and thus, generation of a spark can be prevented. Therefore, a solid product does not catch fire or explode in the vacuum container.

Moreover, the present disclosure (claim 2) is a disclosure of a vacuum pump, characterized in that a magnetic bearing that supports the rotor shaft in levitated manner in the air is provided, the rotor shaft is held by the magnetic bearing in a non-contact manner with a predetermined movable width, and the protection portion is formed thicker than the predetermined movable width.

By forming the protection portion thicker than the movable width of the rotor shaft, a distance between the metals of the rotor blade and the stationary portion can be taken larger than the movable width of the rotor shaft, and an effect of preventing contact between the metals is improved. Moreover, since the protection portion may be formed of a material which is chipped easily when the rotor blade and the stationary portion are brought into contact, a variety in selection of the materials for the protection portion is widened.

By selecting the material that is chipped easily, when the rotor blade and the stationary portion are brought into contact, not only that an impact when the rotor blade and the stationary portion are brought into contact can be alleviated, but also a clearance between the rotor blade and the stationary portion is widened, and re-contact does not occur easily and thus, an effect of preventing repeated collision after an abnormality is detected until the pump is completely stopped can be also expected.

Moreover, the present disclosure (claim 3) is a disclosure of a vacuum pump, characterized in that the protection portion is formed with a thickness of 0.1 mm or more.

The thickness of 0.1 mm or more is a dimension that can avoid such an incident that metals of the base materials are exposed and contacted with each other, since the protection portion is contacted first and chipped, when the rotor blade and the stationary portion are contacted with each other. Since the protection portion also has certain hardness, by setting the thickness of 0.1 mm or more, the exposure and contact of the metals of the base materials can be avoided more effectively, combined with an action of repelling a substance.

Furthermore, the present disclosure (claim 4) is a disclosure of a vacuum pump, characterized in that the protection portion is disposed on a head part of a protruding portion protruded from at least either one of the stator and the rotor blade.

Since the protection portion is formed partially on the head part of the protruding portion protruded from the stator or the rotor blade with the exhaust channel therebetween, constitution with a smaller amount of the material can be realized inexpensively.

Furthermore, the present disclosure describes examples of a vacuum pump, characterized in that the protection portion is formed on a surface opposed to the exhaust channel of at least either one of the rotor blade and the stationary portion.

Coating with the protection portion is also applied to the exhaust channel other than a portion with which contact is expected. Since a friction factor of the protection portion is low, the surface is slippery, and collecting of a solid product which causes an explosion can be prevented.

That is, even if the solid product is generated in compression, it does not adhere to a surface of the stationary portion but is pushed to flow with the gas and thus, the solid product does not collect easily in this area. By disposing the protection portion as above, an explosion is prevented, and accumulation of the solid product is prevented, which are double safety measures.

Moreover, the present disclosure describes examples of a vacuum pump, characterized in that the protection portion has a spiral protruding portion opposed to the rotor blade protruded from an inner peripheral side of a cylindrical portion, and an outer peripheral side of the cylindrical portion is fixed to the stator.

Since the spiral protruding portion is formed on the inner peripheral side of the protection portion, an exhaust performance is ensured. A portion opposed to the exhaust channel is non-metal, and even if the rotor blade and the stationary portion are brought into contact, the metals are not contacted with each other and thus, a spark is not generated. Therefore, a solid product does not catch fire or explode.

Furthermore, the present disclosure (claim 7) is a disclosure of a vacuum pump, characterized in that the protection portion is formed of a fluorine resin.

Since the fluorine resin has a low friction factor, it can be constituted such that the rotor blade can slide on the surface of the protection portion easily, and an impact at a collision can be alleviated. Thus, an effect of preventing a spark is improved. Moreover, the emissivity of heat from the protection portion is also high, and it is a desirable material in a point that it has hardness of such a degree that the protection portion is not broken easily by a collision between the rotor blade and the stationary portion. Moreover, the effect of preventing adhesion of a reactive product and of avoiding a substance which catches a fire can be also expected.

Furthermore, the present disclosure describes examples of a vacuum pump, characterized in that the protection portion is formed of a composite material made of a particle of a fluorine resin and a resin fixing the particle.

When the protection portion is formed of the composite material, such a nature is generated that the hardness of the protection portion is lowered and the protection portion becomes fragile. In this case, such an effect can be expected that an impact at a collision can be alleviated while it is chipped but certain rigidity is maintained at the contact.

Furthermore, the present disclosure describes examples of a protection portion, characterized by being formed of non-metal and provided in the vacuum pump described in any one of claims 1 to 8.

As described above, according to the present disclosure (claim 1), since it is constituted by providing the protection portion made of non-metal and having a thickness which can prevent contact between metals when the rotor blade and the stationary portion are brought into contact on at least on a part of the rotor blade and the stationary portion, even if the rotor blade and the stationary portion are brought into contact, the metals are not exposed or contacted. Therefore, generation of a spark can be prevented. Therefore, a solid product does not catch fire or explode in a vacuum container.

### BRIEF DESCRIPTION OF THE DRAWINGS

FIG. 1 is a configuration diagram of a turbo-molecular pump, which is a first embodiment of the present disclosure.

FIG. 2 is an enlarged view around a rotor blade and a threaded spacer.

FIG. 3 is a configuration diagram of a second embodiment of the present disclosure.

FIG. 4 is a configuration diagram of a third embodiment of the present disclosure.

### DETAILED DESCRIPTION

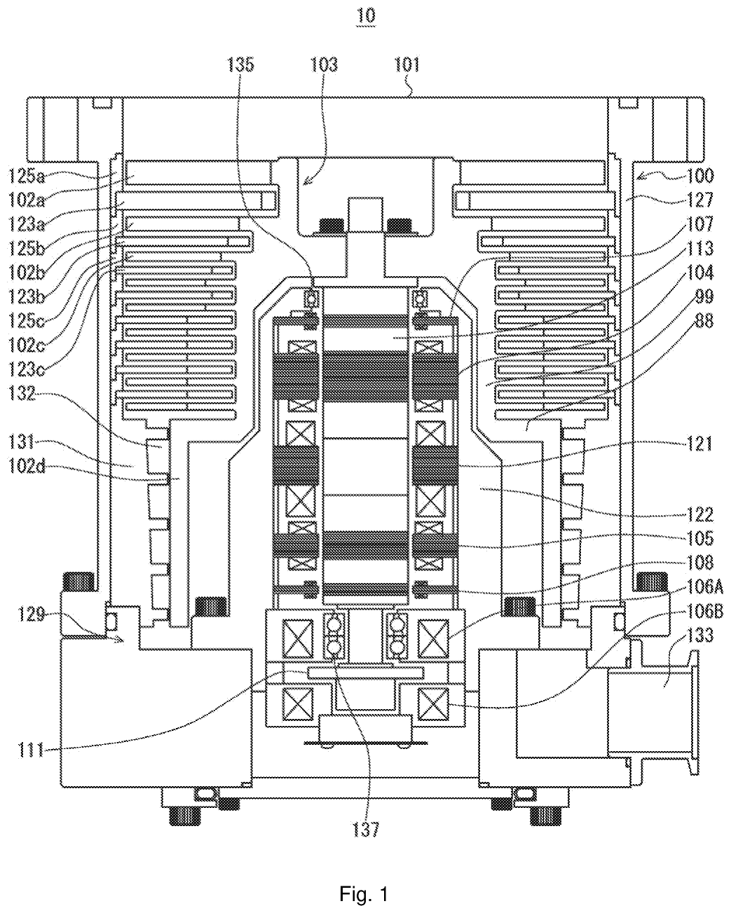

Hereinafter, embodiments of the present disclosure will be described. FIG. 1 shows a configuration diagram of a turbo-molecular pump, which is a first embodiment of the present disclosure.

In FIG. 1, an inlet port 101 is formed in an upper end of a cylindrical outer cylinder 127 of a pump main body 100 in a turbo-molecular pump 10. Inside the outer cylinder 127, a rotating body 103 in which a plurality of rotor blades 102a, 102b, 102c, . . . by turbine blades for sucking/exhausting a gas are formed radially and in multiple stages in a peripheral portion of a hub 99 is provided.

A rotor shaft 113 is mounted at a center of this rotating body 103, and this rotor shaft 113 is supported in levitated manner in the air by a so-called five-axial control magnetic bearing and positionally controlled, for example.

With respect to upper-side radial electromagnets 104, four electromagnets are disposed in pairs on an X-axis and a Y-axis, which are coordinate axes of the rotor shaft 113 in a radial direction and orthogonal to each other. Four pieces of upper-side radial displacement sensors 107 including coils are provided in a vicinity and correspondingly to the upper-side radial electromagnets 104. This upper-side radial displacement sensor 107 is constituted to detect radial displacement of the rotor shaft 113 and to send it to a control device, not shown.

In the control device, on the basis of a displacement signal detected by the upper-side radial displacement sensor 107, excitation of the upper-side radial electromagnet 104 is controlled through a compensation circuit having a PID adjustment function, and a radial position on an upper side of the rotor shaft 113 is adjusted.

The rotor shaft 113 is formed of a highly-permeable material (iron or the like) and is constituted to be attracted by a magnetic force of the upper-side radial electromagnet 104. Such adjustment is independently conducted in an X-axis direction and a Y-axis direction, respectively.

Moreover, a lower-side radial electromagnet 105 and a lower-side radial displacement sensor 108 are disposed similarly to the upper-side radial electromagnet 104 and the upper-side radial displacement sensor 107, and a radial position on a lower side is adjusted similarly to the radial position on the upper side of the rotor shaft 113.

Furthermore, axial electromagnets 106A, 106B are disposed with a disc-shaped metal disc 111 provided on a lower part of the rotor shaft 113 sandwiched vertically. The metal disc 111 is constituted by a material with high magnetic permeability such as iron.

And the axial electromagnets 106A, 106B are configured to be excited/controlled through a compensation circuit having the PID adjustment function of the control device on the basis of an axial displacement signal of an axial displacement sensor, not shown. The axial electromagnet 106A and the axial electromagnet 106B attract the metal disc 111 upward and downward by the magnetic force, respectively.

As described above, the control device adjusts the magnetic force applied to the metal disc 111 by the axial electromagnets 106A, 106B as appropriate, magnetically floats the rotor shaft 113 in the axial direction, and holds it in a space in a non-contact manner.

A motor 121 includes a plurality of magnetic poles disposed in a peripheral state so as to surround the rotor shaft 113. Each of the magnetic poles is controlled by the control device so as to drive the rotor shaft 113 to rotate through an electromagnetic force acting between itself and the rotor shaft 113.

A plurality of stator blades 123a, 123b, 123c, . . . are disposed with a slight clearance from the rotor blades 102a, 102b, 102c . . . . The rotor blades 102a, 102b, 102c . . . are formed with inclination only by a predetermined angle from a plane perpendicular to an axis of the rotor shaft 113 in order to transfer a molecule of an exhaust gas to a lower direction by a collision, respectively.

Moreover, the stator blade 123 is similarly formed with inclination only by a predetermined angle from a plane perpendicular to an axis of the rotor shaft 113 and is disposed alternately with a stage of the rotor blade 102 toward an inside of the outer cylinder 127.

And one end of the stator blade 123 is supported in a state fitted/inserted between stator blade spacers 125a, 125b, 125c . . . stacked in plural stages.

A stator blade spacer 125 is a ring-shaped member and is constituted by metal such as aluminum, iron, stainless, copper and the like or an alloy containing these metals as components, for example.

On an outer periphery of the stator blade spacer 125, the outer cylinder 127 is fixed with a slight clearance therebetween. A base portion 129 is disposed on a bottom part of the outer cylinder 127, and a threaded spacer 131 corresponding to the stator is disposed between a lower part of the stator blade spacer 125 and the base portion 129. And an outlet port 133 is formed in a lower part of the threaded spacer 131 in the base portion 129 and communicates with an outside.

The threaded spacer 131 is a cylindrical member constituted by metal such as aluminum, copper, stainless, iron or an alloy with these metals as components and the like, and spiral thread grooves 132 are engraved in plural rows in an inner periphery surface thereof.

A direction of a spiral of the thread groove 132 is a direction in which a molecule of an exhaust gas is transferred toward the outlet port 133, when the molecule moves in a rotating direction of the rotating body 103.

On a lower end of a hub 99 of the rotating body 103, an extended portion 88 is formed radially and horizontally, and a rotor blade 102d is hung from a peripheral end of this extended portion 88. An outer peripheral surface of this rotor blade 102d has a cylindrical shape and extends toward the inner peripheral surface of the threaded spacer 131 and is proximate to the inner peripheral surface of this threaded spacer 131 with a predetermined clearance.

The base portion 129 is a disc-shaped member constituting a bottom part of the turbo-molecular pump 10 and is constituted by metal such as iron, aluminum, stainless and the like in general.

The base portion 129 physically holds the turbo-molecular pump 10 and also functions as a conduction path of heat and thus, metal with rigidity and also with high heat conductivity such as iron, aluminum, copper and the like are desirably used.

Moreover, an electric component portion is covered with a stator column 122 on a periphery thereof so that a gas sucked through the inlet port 101 does not enter the electric component portion side constituted by the motor 121, the lower-side radial electromagnet 105, the lower-side radial displacement sensor 108, the upper-side radial electromagnet 104, the upper-side radial displacement sensor 107 and the like, and an inside of this electric component portion is kept at a predetermined pressure by a purge gas.

Furthermore, around the rotor shaft 113 on an upper part and a lower part of the stator column 122, a protection bearing 135 and a protection bearing 137 constituted by an annular ball bearing, respectively, are disposed. These protection bearings 135, 137 are provided so that, when the rotating body 103 cannot be magnetically floated due to some factor such as at rotation abnormality of the rotating body 103, electric outage or the like, the rotating body 103 can be safely transferred to a non-floating state and stopped.

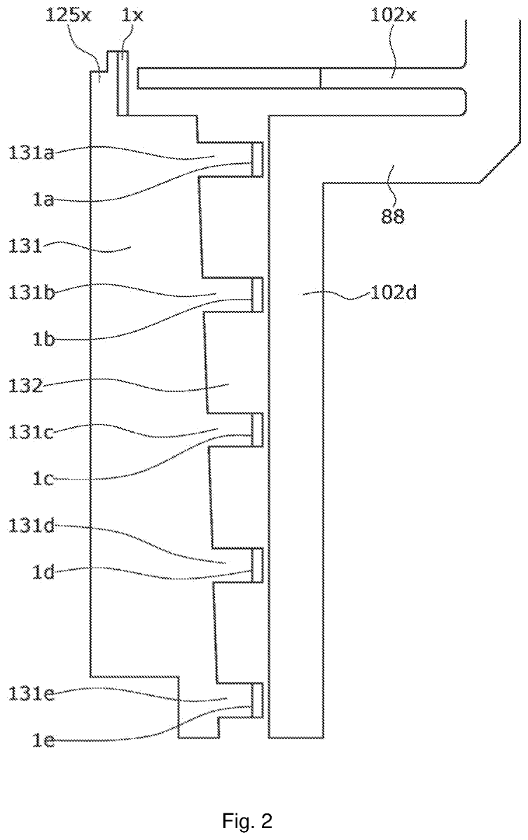

FIG. 2 shows an enlarged view around the rotor blade 102d and the threaded spacer 131.

In FIG. 2, on head parts of a thread ridge 131a to a thread ridge 131e of the threaded spacer 131, a protection portion 1a to a protection portion 1e made of non-metal are formed in a peripheral state. Moreover, a protection portion 1x is also formed in the peripheral state on an inner peripheral surface of the stator blade spacer 125x opposed to a distal end of the rotor blade 102x.

Subsequently, an action of the first embodiment of the present disclosure will be described.

In the turbo-molecular pump 10, a clearance between the rotor blade 102 rotating at a high speed and the stationary portion including the stator blade 123, the threaded spacer 131, and the stator blade spacer 125 is extremely small. Thus, if a solid product such as a condensed component of an exhaust gas is deposited inside the pump main body 100 or if the rotating body is deformed by a creeping phenomenon or the like, there is a concern that the rotor blade 102 is brought into contact with the stationary portion.

Particularly, the solid products can be deposited easily in a larger amount in the vicinity of the base portion 129. Thus, as illustrated in FIG. 2, there is a high possibility that the metals are brought into contact with each other in a narrow part of a gas channel between the outer periphery of the rotor blade 102d and the head parts of the thread ridge 131a to the thread ridge 131e of the threaded spacer 131. Then, on the head part sides of the thread ridge 131a to the thread ridge 131e of the threaded spacer 131 with this narrow clearance of the gas channel therebetween, the protection portion 1a to the protection portion 1e made of non-metal are formed in the peripheral state. Moreover, the protection portion 1x is formed similarly in the peripheral state also on the inner peripheral surface side of the stator blade spacer 125x opposed to the distal end of the rotor blade 102x with the narrow clearance of the gas channel.

The protection portion 1 is formed of non-metal with a necessary and sufficient thickness so that metal materials of the base materials are not brought into contact with each other also when the rotor blade 102 and the stationary portion are brought into contact with each other. This non-metal is a fluorine resin, an epoxy resin, polyphenylene sulfide (PPS), urethane and the like. Among them, the fluorine resin has a low friction factor and thus, the rotor blade 102 can easily slide on a surface of the protection portion 1, and an impact at a collision can be also reduced. Moreover, it is the most desirable material in points that the heat emissivity from the protection portion 1 is also high, and the protection portion 1 has hardness of such a degree that it is not broken easily by a collision between the rotor blade 102 and the stationary portion. Furthermore, effects of preventing adhesion of a reactive product and of avoiding substances which catch fire can be also expected.

However, the protection portion 1 may be formed of a composite material in which particles of the fluorine resin are dispersed in a heat-resistant resin such as an epoxy resin, PPS and the like.

The necessary and sufficient thickness of the protection portion 1 is 0.1 mm or more, for example. This thickness is such a dimension that, when the rotor blade 102 and the stationary portion are brought into contact, the protection portion 1 is contacted first and chipped so that exposure and contact of the metals of the base materials can be avoided. Since the protection portion 1 also has certain hardness, by setting the thickness to 0.1 mm or more, the exposure and contact of the metals of the base materials can be avoided more effectively, combined with the action of repelling a substance.

Moreover, when the protection portion 1 is formed of the composite material, such a nature is generated that hardness of the protection portion 1 is lowered and the protection portion 1 becomes fragile. In this case, such an effect can be expected that the impact at the collision can be alleviated while it is chipped but certain rigidity is maintained at the contact.

As described above, even when the rotor blade 102 and the stationary portion are contacted, the metals are not exposed or contacted and thus, generation of a spark can be prevented. Therefore, the solid product does not catch fire or explode in the vacuum container.

In this embodiment, since the protection portion 1 is formed partially only on the head parts of the thread ridge 131a to the thread ridge 131e of the threaded spacer 131 and the inner peripheral surface portion of the stator blade spacer 125x opposed to the distal end of the rotor blade 102x, constitution with a smaller amount of the material can be realized inexpensively.

It is to be noted that forming of the protection portion 1a to the protection portion 1e made of non-metal in the peripheral state on the head part sides of the thread ridge 131a to the thread ridge 131e of the threaded spacer 131 with the narrow clearance of the gas channel therebetween is described in FIG. 2, but the protection portion may be formed on the outer peripheral surface of the rotor blade 102d opposed to the head parts of the thread ridge 131a to the thread ridge 131e. Moreover, the protection portion may be formed on the both surfaces with the opposed gas channel therebetween.

Similarly, forming of the protection portion 1x on the inner peripheral surface side of the stator blade spacer 125x in the peripheral state opposed to the distal end of the rotor blade 102x with the narrow clearance of the gas channel is described, but the protection portion 1x may be formed on the distal end side of the rotor blade 102x in the peripheral state.

The protection portion 1 is formed by thickening painting such as spraying a resin or the like while thickness control is executed by a robot, for example. Alternatively, it may be created as a seal-state stator component, and this stator component may be bonded to the head parts or the like of the thread ridge 131a to the thread ridge 131e of the threaded spacer 131.

Furthermore, in FIG. 2, forming on the head parts of the thread ridge 131a to the thread ridge 131e of the threaded spacer 131 and on the inner peripheral surface of the stator blade spacer 125x with the narrow clearance of the gas channel therebetween is described. However, the solid product is not deposited only on these spots, and there is a possibility that it is deposited or adheres to the surfaces of the rotor blades 102a, 102b, 102c . . . , the stator blades 123a, 123b, 123c, . . . , and the stator blade spacers 125a, 125b, 125c, . . . with the narrow clearance of the gas channel therebetween, closer to the inlet port 101 side than these spots. Thus, the protection portion 1 similar to the above may also be formed on these spots.

Subsequently, a second embodiment of the present disclosure will be described.

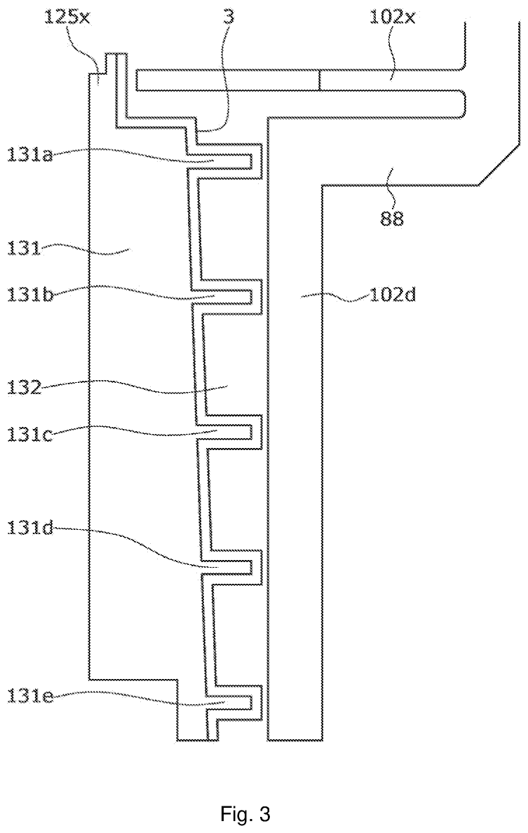

A configuration diagram of the second embodiment of the present disclosure is shown in FIG. 3. Description will be omitted for the same elements as those in FIG. 2. In FIG. 3, the head parts of the thread ridge 131a to the thread ridge 131e of the threaded spacer 131, a bottom surface and a side surface of the thread groove 132, the entire one side surface of the threaded spacer 131 including the stator blade spacer 125x along the gas exhaust channel are coated with the protection portion 1.

Subsequently, an action of the second embodiment of the present disclosure will be described.

In the second embodiment of the present disclosure, unlike the first embodiment, coating with a protection portion 3 is also applied to the exhaust channel other than the portion with which contact is expected. Since the friction factor of the protection portion 3 is low, the surface is slippery, and collection of the solid product which causes an explosion can be prevented for any portion in the threaded spacer 131. That is, even if the solid product is generated in compression, it does not adhere to the surface of the threaded spacer 131 but is pushed to flow with the gas and thus, the solid product does not collect easily in this area. By disposing the protection portion 3 as above, an explosion is prevented, and accumulation of the solid product is prevented, which are double safety measures.

The protection portion 3 may be similarly formed by thickening painting described above but may be formed by placing a die with a predetermined thickness and casting a resin therebetween. That is, it may be formed by casting/molding a resin on the surface of the threaded spacer 131.

Moreover, the protection portion 3 may be separately created as a stator component by casting/molding or the like, and this stator component may be bonded to the stator. Furthermore, the protection portion 3 may be disposed by exceeding a range indicated in FIG. 3 over a wide range of the stationary portion close to the inlet port 101. Still further, the protection portion 3 may be disposed on the rotor blade 102 side opposed to the exhaust channel.

Subsequently, a third embodiment of the present disclosure will be described.

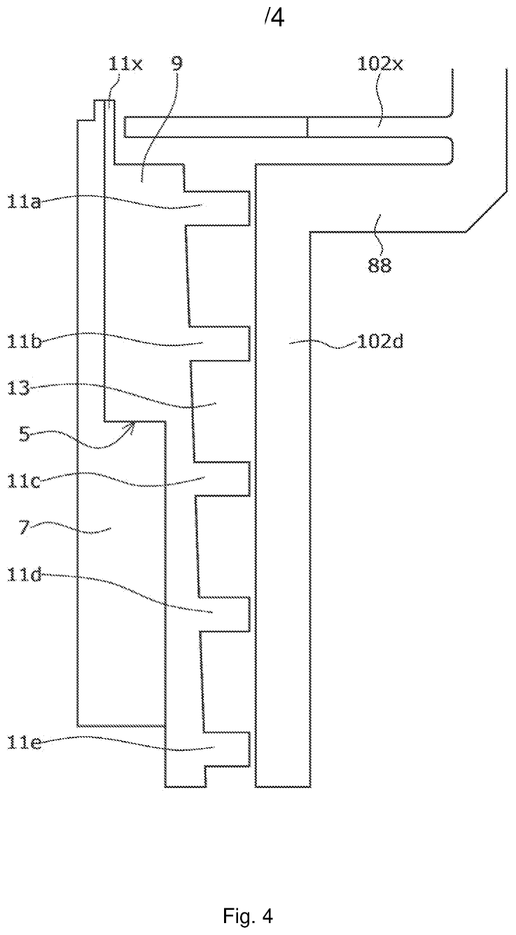

A configuration diagram of the third embodiment of the present disclosure is shown in FIG. 4. It is to be noted that description will be omitted for the same elements as those in FIG. 2. In FIG. 4, on an inner peripheral wall of the cylindrical portion 7 with a step 5 with a different inner diameter formed, a protection portion 9 is fixed by an adhesive or a bolt or the like. An inner peripheral side of the protection portion 9 is formed similarly to the shape of the threaded spacer 131. That is, head parts of a thread ridge 11a to a thread ridge 11e and a thread groove 13 are engraved along the exhaust channel of the gas. On the other hand, an outer peripheral side of the protection portion 9 has a step formed correspondingly to the step 5 of the cylindrical portion 7. On an upper part of the protection portion 9, a wall portion 11x corresponding to a portion of the stator blade spacer 125x is protruded.

Subsequently, an action of the third embodiment of the present disclosure will be described.

On the inner peripheral wall of the cylindrical portion 7, the protection portion 9 is reliably fixed through the step 5. On the inner peripheral side of the protection portion 9, the thread groove 13 is formed so that an exhaust performance is ensured. Since the stationary portion side of the exhaust channel is a resin, an effect similar to those of the first embodiment and the second embodiment can be expected.

It is to be noted that the protection portion 9 is separately molded as a resin stator component. Moreover, the molded protection portion 9 may be fixed to the rotor blade 102, the extended portion 88, and the rotor blade 102d sides. Furthermore, all the rotor blade 102, the extended portion 88, and the rotor blade 102d may be molded as the stator component of the protection portion 9.

Subsequently, a synergistic action with a protection bearing when the protection portion is disposed will be described.

Since the protection bearing 135 and the protection bearing 137 are disposed, fluctuation of the rotor shaft 113 is limited within a certain range even at the rotation abnormality of the rotating body 103 or the like. This range is 0.1 mm, which is a clearance of the protection bearings, for example.

If the protection portion 1, 3 or 9 is not provided, a size of this clearance does not change. Thus, when the metals of the threaded spacer 131 and the rotor blade 102 collide against each other, the collision is repeated while an impact at the collision remains large. Thus, there is a concern that an impact cannot be well suppressed by the protection bearing 135 or 137.

On the other hand, if the protection portion 1, 3 or 9 is provided, the resin is chipped with the collision, whereby the clearance is widened to 0.2 mm or the like, for example, and occurrence of further contact can be prevented. Thus, the impact can be suppressed easily by the protection bearing 135 or 137.

At this time, if the entire protection portion is not formed with a uniform thickness, but a slit or a portion with a smaller thickness is provided in a lattice state at an interval of several mm, it can be constituted such that the entire protection portion is not removed even at the contact but only the contact spot and a periphery thereof are chipped. However, it may be constituted such that the slit or the like is provided only in a vertical direction or in a lateral direction.

As a result, functions of the protection bearings 135 and 137 to stop the rotating body 103 can be improved stably.

It is to be noted that, in the above-described description of each of the embodiments, it was described that the thread ridge 131a to the thread ridge 131e are disposed on the inner peripheral surface side of the threaded spacer 131. However, the thread ridge 131a to the thread ridge 131e may be disposed not on the inner peripheral surface side of the threaded spacer 131 but on the outer peripheral surface side of the rotor blade 102d.

Moreover, the threaded spacer 131 is formed having a disc shape, and the thread ridge 131a to the thread ridge 131e are protruded spirally on a plane of this disc. And this surface with protrusion may be configured to be opposed to the rotor blade 102 formed having a disc shape through the exhaust channel.

It is to be noted that the present disclosure can be altered in various ways unless the spirit of the present disclosure is not departed, and it is natural that the present disclosure also includes those altered.

1. A vacuum pump comprising:
an outer cylinder;
a rotor shaft supported rotatably in the outer cylinder;
a rotary drive means for driving the rotor shaft to rotate;
a rotor blade made of metal and having a blade row fixed to the rotor shaft;
a stationary portion made of metal and constituted by at least any one of a stator blade installed between the blade row of the rotor blades, a stator blade spacer for holding the stator blade with a predetermined interval, and a stator installed in a periphery of the rotor blade;
an exhaust channel formed between the rotor blade and the stationary portion; and
a protection portion made of non-metal and having a thickness that prevents contact between metals when the rotor blade and the stationary portion are brought into contact in at least on a part of the rotor blade and the stationary portion.

2. The vacuum pump according to claim 1, wherein
a magnetic bearing that supports the rotor shaft in levitated manner in the air is provided; and
the rotor shaft is held by the magnetic bearing in a non-contact manner with a predetermined movable width, and the protection portion is formed thicker than the predetermined movable width.

3. The vacuum pump according to claim 1, wherein
the protection portion is formed with a thickness of 0.1 mm or more.

4. The vacuum pump according to claim 1, wherein:
the protection portion is disposed on a head part of a protruding portion protruded from at least either one of the stator and the rotor blade.

5. The vacuum pump according to claim 1, wherein:
the protection portion is formed on a surface opposed to the exhaust channel of at least either one of the rotor blade and the stationary portion.

6. The vacuum pump according to claim 1, wherein:
the protection portion has a spiral protruding portion opposed to the rotor blade protruded from an inner peripheral side of a cylindrical portion; and
an outer peripheral side of the cylindrical portion is fixed to the stator.

7. The vacuum pump according to claim 1, wherein:
the protection portion is formed of a fluorine resin.

8. The vacuum pump according to claim 1, wherein:
the protection portion is formed of a composite material made of a particle of a fluorine resin and a resin fixing the particle.

9. A protection portion, wherein the protection portion is formed of non-metal and configured for a vacuum pump comprising:
an outer cylinder;
a rotor shaft supported rotatably in the outer cylinder;
a rotary drive means for driving the rotor shaft to rotate;
a rotor blade made of metal and having a blade row fixed to the rotor shaft;
a stationary portion made of metal and constituted by at least any one of a stator blade installed between the blade row of the rotor blades, a stator blade spacer for holding the stator blade with a predetermined interval, and a stator installed in a periphery of the rotor blade;
an exhaust channel formed between the rotor blade and the stationary portion,
wherein the non-metal of the protection portion has a thickness sufficient to prevent contact between metals when the rotor blade and the stationary portion are brought into contact in at least on a part of the rotor blade and the stationary portion.
